(19) United States
(12) Patent Application Publication
(10) Pub. No.: US 2016/0131821 A1
(43) Pub. Date: May 12, 2016

(54) ILLUMINATION DEVICE, DISPLAY DEVICE, AND TV RECEIVER

(71) Applicant: SHARP KABUSHIKI KAISHA, Osaka (JP)

(72) Inventor: Takaharu SHIMIZU, Osaka (JP)

(73) Assignee: Sharp Kabushiki Kaisha, Osaka (JP)

(21) Appl. No.: 14/895,889

(22) PCT Filed: Feb. 28, 2014
(86) PCT No.: PCT/JP2014/055018

§ 371 Date: Dec. 3, 2015

(30) Foreign Application Priority Data
Jun. 6, 2013 (JP) 2013-119819

(51) Int. Cl. F21V 8/00; H04N 5/44

(52) U.S. Cl. CPC G02B 6/0068; G02B 6/0073; H04N 5/44

(57) ABSTRACT

A backlight device includes: a light guide plate, at least one end face thereof being a light-receiving face; and a plurality of light-emitting units arranged in a row along the light-receiving face such that light emitted from light-emitting units enters the light-receiving face of the light guide plate, wherein the plurality of light-emitting units are grouped into a plurality of groups such that an amount of light emitted by each light-emitting unit in a center group on a center-side of the row is less than an amount of light emitted by each light-emitting unit in a peripheral group on a relatively end-side of the row.

### TECHNICAL FIELD

The present invention relates to an illumination device, a display device and a television receiver.

### BACKGROUND ART

A liquid crystal display device such as a liquid crystal television separately requires a backlight device as an illumination device, because its display panel, a liquid crystal panel, does not emit light, for example. Such backlight devices are broadly classified as direct-lit backlight devices and edge-lit backlight devices in accordance with their structures. To achieve a further thickness reduction of the liquid crystal display device, it is preferable to use an edge-lit backlight device.

In such an edge-lit backlight device, a light guide plate that guides light that has been emitted from light sources such as light-emitting diodes (LEDs) toward a light-exiting surface provided on one surface of the light guide plate is housed inside a casing. A light-receiving face is provided at at least one end face of the light guide plate and a plurality of light sources are arranged so as to face the light-receiving face.

In the backlight device, narrowing of a frame portion of the backlight device, so called frame narrowing, may be required for design reasons. The distance between the light sources and a display region of a display surface in a backlight device that has undergone frame narrowing is shorter than that in a backlight device that has not undergone frame narrowing. In such a case, a phenomenon occurs in which an image of light emitted from a plurality of LEDs arranged so as to face the light-receiving face is easily visually recognized on the display surface. In order to avoid this phenomenon, it is effective to narrow the gaps among the plurality of LEDs in a backlight device that has undergone frame narrowing.

However, when the gaps between the plurality of LEDs are made narrower, there is greater overlapping of light emitted from the LEDs in the center of the light-receiving face of the light guide plate than at the ends of the light-receiving face of the light guide plate, and therefore the amount of light at the ends of the light-receiving face is insufficient compared with the amount of light in the center. Therefore, with such a backlight device, the ends of the display surface may be relatively dark compared with the center of the display surface and the brightness distribution on the display surface may be non-uniform. A backlight unit aiming to eliminate such non-uniformity of the brightness distribution on the display surface is disclosed in Patent Document 1, for example.

### RELATED ART DOCUMENT

### Patent Document

Patent Document 1: Japanese Patent Application Laid-Open Publication No. 2012-242649

### Problems to be Solved by the Invention

However, in the backlight unit of Patent Document 1, non-uniformity of the brightness distribution on the display surface is eliminated by arranging an optical sheet, which can control the brightness distribution of the entire display surface so as to be uniform, between the light guide plate and the display surface. The optical sheet has a structure that includes a plurality of substantially hemispherical lenses and a plurality of arrayed continuous geometrical structures. Consequently, there is a problem in that the path of light that passes through the optical sheet is long and the use efficiency of light decreases.

### SUMMARY OF THE INVENTION

The technology disclosed in the present specification was made in view of the above-mentioned problems. An objective of the disclosure in the present specification is to provide a technology that can decrease non-uniformity of brightness distribution on a display surface without decreasing the use efficiency of light.

### Means for Solving the Problems

The technology described in the present specification relates to an illumination device, including: a light guide plate, at least one end face thereof being a light-receiving face; and a plurality of light-emitting diodes arranged in a row along the light-receiving face such that light emitted from the light-emitting diodes enters the light-receiving face of the light guide plate, wherein the plurality of light-emitting diodes are configured such that, among the plurality of the light-emitting diodes, an amount of light emitted by a light-emitting diode on a center-side of the row is less than an amount of light emitted by a light-emitting diode on a relatively end-side of the row.

According to the illumination device, since there is an increased amount of light at an end of the light-receiving face compared to the center of the light-receiving face, non-uniformity of brightness between the center and the end of a display surface can be prevented or suppressed even if, for example, the gaps between adjacent LEDs have been made narrower and there is consequently greater overlapping of light in the center than at the ends of the light-receiving face. In addition, since there are no lens members or the like arranged along the path of light like in the configuration described in the related art, it is also possible to prevent the use efficiency of light from decreasing. As a result, in the illumination device, even in the case where the gaps between adjacent LEDs are narrower, the uniformity of the brightness distribution on the display surface can be improved without decreasing the use efficiency of light.

The plurality of light-emitting diodes may each include a light-emitting diode element and a resin package that seals the light-emitting diode element therein.

With this configuration, the wiring can be simplified compared with the case where the LEDs are mounted on a substrate or the like in a state where the LED elements are exposed, and therefore the gaps between adjacent LEDs can be made narrower. As a result, the frame region of the illumination device can be made even narrower.

The plurality of light-emitting diodes may be configured such that the light-emitting diode on the relatively end-side of the row may have a greater number of the light-emitting diode elements sealed inside the resin package therein than the light-emitting diode on the center-side of the row.

With this configuration, in the case where the LEDs each include an LED element and a resin package, the uniformity of brightness between the center and an end of the display surface can be improved by merely changing the type of LED.

The plurality of light-emitting diodes may include first light-emitting diodes on the center-side of the row and in which one light-emitting diode element is sealed inside the resin package therein, third light-emitting diodes on the relatively end-side of the row and in which three light-emitting diode elements are sealed inside the resin package therein, and a second diode arranged between the first light-emitting diode and the third light-emitting diode and in which two light-emitting diode elements are sealed inside the resin package therein.

With this configuration, in the case where the LEDs each include an LED element and a resin package, the amount of light emitted in the center and at an end of the row of LEDs can be easily adjusted by using three types of LEDs, and therefore the uniformity of brightness between the center and the end of the display surface can be further improved.

The plurality of light-emitting diodes may be configured such that a size of the light-emitting diode elements sealed inside one of the resin packages may be larger in size in the light-emitting diode on the relatively end-side of the row than in the light-emitting diode on the center-side of the row.

With this configuration, in the case where the LEDs each include an LED element and a resin package, the uniformity of brightness between the center and an end of the display surface can be improved by merely changing the size of the LED element.

The plurality of light-emitting diodes may be configured such that a luminous flux of the light-emitting diode on the relatively end-side of the row may be greater than that of the light-emitting diode on the center side of the row.

With this configuration, the uniformity of brightness between the center and an end of the display surface can be improved by merely changing the performance of the LEDs. In the present specification, luminous flux being larger means that the amount of light is increased by intentionally mounting resin packages having LED elements of a higher quantum efficiency or by mounting LED elements of a larger surface area per unit surface area.

The plurality of light-emitting diodes may be configured such that the amount of light emitted by the light-emitting diode on the center-side of the row may be less than an amount of light emitted by the light-emitting diodes on the respective relatively end-sides of the row.

With this configuration, non-uniformity of brightness between the center and the ends of the display surface can be prevented or suppressed. Therefore, the uniformity of the brightness distribution on the display surface can be further improved.

The plurality of light-emitting diodes may be arranged along the light-receiving face in a straight line with substantially uniform gaps therebetween.

With this configuration, since the LEDs are regularly arranged on an LED substrate or the like in the process of manufacturing the illumination device, the LEDs can be easily arranged compared with a case where the LEDs are irregularly arranged, and the work efficiency of the process of manufacturing the illumination device can be increased.

The techniques disclosed in the present specification can be expressed as a display device including: the illumination device; and a display panel that performs display using light from the illumination device. A display device, in which the display panel is a liquid crystal panel that uses liquid crystal, is also novel and useful. A television receiver that includes the display device is also novel and useful.

### Effects of the Invention

According to the technology disclosed in the present specification, the uniformity of the brightness distribution on a display surface can be improved without decreasing the use efficiency of light.

### BRIEF DESCRIPTION OF THE DRAWINGS

FIG. 1 is an exploded perspective view of a television receiver according to Embodiment 1.

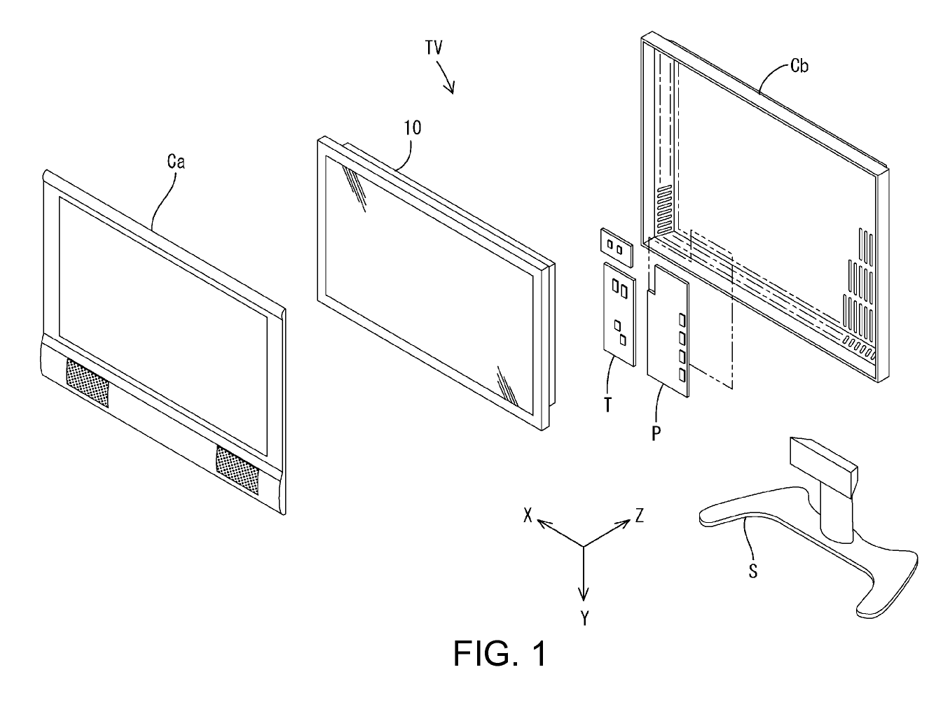

FIG. 2 is an exploded perspective view of a liquid crystal display device.

FIG. 3 is an enlarged cross-sectional view in which a region around an LED in a cross section obtained by cutting the liquid crystal display device along a short-edge direction of a chassis is enlarged.

FIG. 4 is a plan view in which a backlight device is seen from the front.

FIG. 5 is an enlarged plan view in which a region around an LED in FIG. 4 is enlarged.

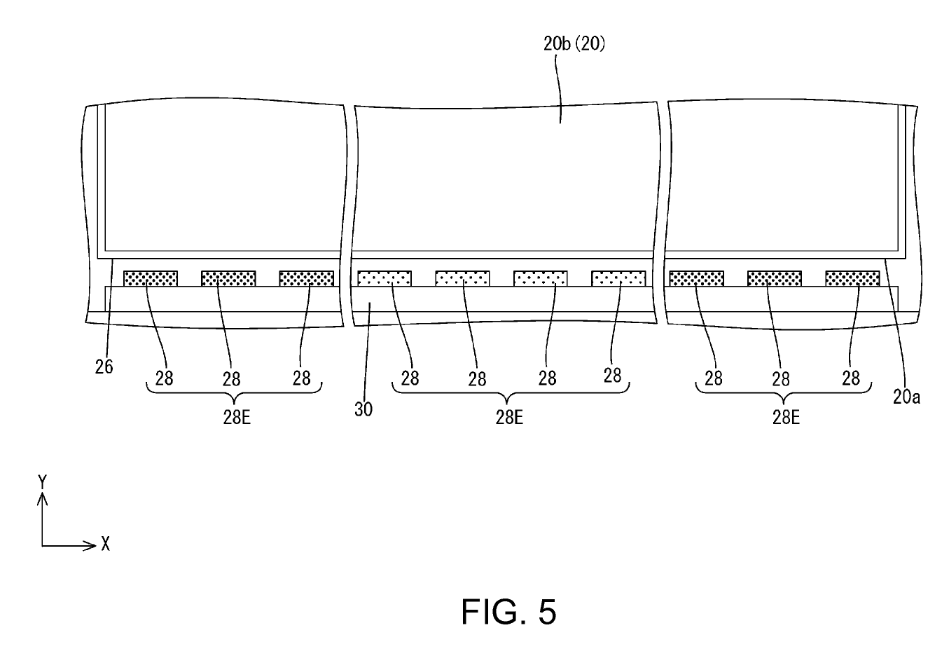

FIG. 6 is a front view of an LED arranged in the center of a row in which a plurality of LEDs are arrayed.

FIG. 7 is a front view of an LED arranged at an end of a row in which a plurality of LEDs are arrayed.

FIG. 8 is a plan view in which a backlight device according to a modification example of Embodiment 1 is seen from the front.

FIG. 9 is a front view of a third LED.

FIG. 10 is a front view of an LED arranged in the center of a row in which a plurality of LEDs are arrayed in Embodiment 2.

FIG. 11 is a front view of an LED arranged at an end of a row in which a plurality of LEDs are arrayed in Embodiment 2.

### DETAILED DESCRIPTION OF EMBODIMENTS

### Embodiment 1

Embodiment 1 will be described with reference to the drawings. In the present embodiment, a television receiver TV will be described as an example. Each of the drawings indicates an X axis, a Y axis, and a Z axis in a portion of the drawings, and each of the axes indicates the same direction for the respective drawings. The Y axis direction corresponds to the vertical direction, and the X axis direction corresponds to the horizontal direction. Unless otherwise noted, “up” and “down” in the description is based on the vertical direction.

The television receiver TV includes a liquid crystal display device (example of display device) 10, front and rear cabinets Ca and Cb that house the liquid crystal display device 10 therebetween, a power source P, a tuner T, and a stand S. The liquid crystal display device 10 has a horizontally-long quadrangular shape as a whole and includes a liquid crystal panel 16, which is a display panel, and a backlight device (an example of an illumination device) 24, which is an external light source. These are integrally held together by a component such as a bezel 12 having a frame-like shape. In the liquid crystal display device 10, the liquid crystal panel 16 is assembled with the display surface capable of displaying an image facing the front side.

Next, the liquid crystal panel 16 is described. In the liquid crystal panel 16, a pair of transparent (having a high degree of light transmission characteristics) glass substrates are bonded together with a prescribed gap therebetween, and a liquid crystal layer (not shown) is sealed between the glass substrates. One of the glass substrates is provided with switching elements (such as TFTs) connected to source lines and gate lines that intersect each other, pixel electrodes connected to the switching elements, an alignment film, and the like. The other glass substrate is provided with color filters including respective colored portions of R (red), G (green), B (blue), and the like, which are in a prescribed arrangement, an opposite electrode, an alignment film, and the like. Of these, the source lines, the gate lines, the opposite electrode, and the like are supplied with image data and various control signals from a driver circuit substrate, which is not shown, necessary for displaying an image. Polarizing plates (not shown) are arranged on the respective outer sides of the glass substrates.

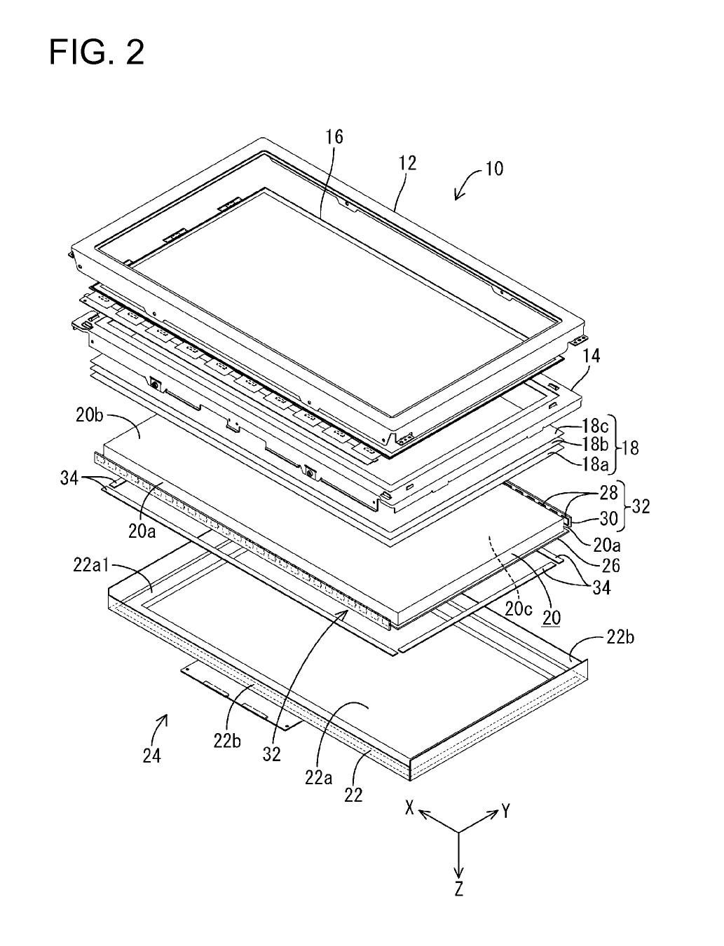

Next, the backlight device 24 is described. As shown in FIG. 2, the backlight device 24 includes a chassis 22 that has a substantially box-like shape that is open toward the front side (light-exiting side, liquid crystal panel 16 side), a frame 14 that is arranged on the front side of the chassis 22, and an optical member 18 arranged so as to cover an opening in the frame 14. In addition, a pair of light-emitting diode (LED) units 32, four spacers 34, a reflective sheet 26 and a light guide plate 20 are housed inside the chassis 22. Both side faces (light-receiving faces) 20a on the long sides of the light guide plate 20 are disposed so as to face the respective LED units 32 and guide the light emitted from the LED units 32 towards the liquid crystal panel 16. The optical member 18 is placed on the front side of the light guide plate 20. The backlight device 24 of the present embodiment uses the so-called edge-lit method (side-lit method), in which the light guide plate 20 and the optical member 18 are disposed directly below the liquid crystal panel 16, and the LED units 32, which are the light sources, are disposed on the side edges of the light guide plate 20. Each component of the backlight device 24 is described in detail below.

The chassis 22 is composed of metal plates such as aluminum plates or electrolytic zinc-coated steel plates (SECC) and as shown in FIG. 2 is formed of a bottom plate 22a having a horizontally-long quadrangular shape similar to the liquid crystal panel 16, side plates 22b that stand upright from the two long outer sides of the bottom plate 22a, and side plates that stand upright from the two short outer sides of the bottom plate 22a. The space in the chassis 22 between the LED units 32 is the space for housing the light guide plate 20 described later. The long-side direction of the chassis 22 (bottom plate 22a) corresponds to the X axis direction (horizontal direction) and the short-side direction of the chassis 22 corresponds to the Y axis direction (vertical direction). A frame-shaped (in a plan view) protruding section 22a1 that protrudes towards the light guide plate 20 is disposed on the end edge areas of the surface of the bottom plate 22a. The top surface of the protruding section 22 is flat and it is possible to place the light guide plate 20 along the end edges thereof with the spacers 34 therebetween. The protruding section 22a1 supports the light guide plate 20 and the reflective sheet 26, which are housed inside the chassis 22, from below. A control substrate, which is not shown, for supplying driving signals to the liquid crystal panel 16 is attached to the outside of the back side of the bottom plate 22a. In a manner similar to the control substrate described above, other substrates such as an LED driver circuit substrate (not shown) that provides driving power to the LED units 32 are attached to the bottom plate 22a.

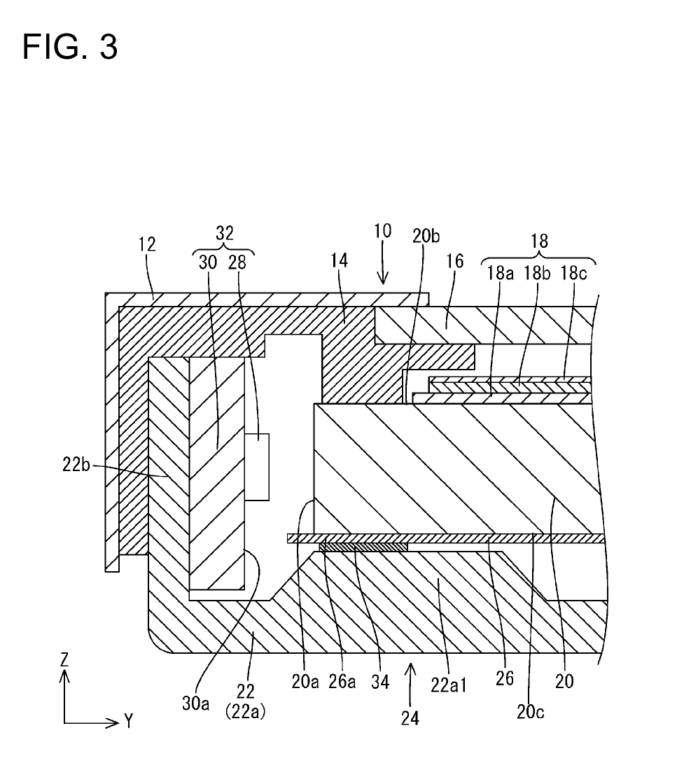

The frame 14 is made of a synthetic resin such as plastic and, as shown in FIGS. 2 and 3, is composed of a part that is parallel to the optical member 18 and the light guide plate 20 (the liquid crystal panel 16) and has an approximately frame-like shape in a plan view, and a part that protrudes toward the back side from the periphery of the frame and has an approximately short tube-like shape. The part of the frame 14 that has an approximately frame-like shape extends along the periphery of the light guide plate 20 and can cover from the front side almost the entire periphery of the optical member 18 and the light guide plate 20 disposed on the back side of the frame. At the same time, the part of the frame 14 having an approximately frame-like shape can receive (support) from the back side almost the entire periphery of the optical member 18 disposed on the front side. In other words, the part of the frame 14 having an approximately frame-like shape is interposed between the optical member 18 and the light guide plate 20. In addition, one of the long sides of the part of the frame 14 having an approximately frame-like shape collectively covers from the front side the edge of the light guide plate 20 on the side of the light-receiving face 20a and the LED units 32. The part of the frame 14 having an approximately short tube-like shape is attached by being appended to the outer surface of the side walls 22b of the chassis 22. The outer surface of the portion described above is disposed as to abut the inner surface of the tube-like surface of the bezel 12 described above.

The optical member 18 is constituted by stacking a diffusion sheet 18a, a lens sheet 18b, and a reflective polarizing plate 18c in this order from the light guide plate 20 side. The diffusion sheet 18a, the lens sheet 18b, and the reflective polarizing plate 18c change the light emitted from the LED units 32 and transmitted through the light guide plate 20 into planar light. The liquid crystal panel 16 is disposed on the upper side of the reflective polarizing plate 18d, and the optical member 18 is disposed in a stable manner being sandwiched between the frame 14 and the liquid crystal panel 16. In short, the optical member 18 is slightly larger than the inner edges of the frame 14 and disposed on the front surface of the inner edges of the frame 14. Thus, as shown in the cross-sectional view in FIG. 3, the frame 14 separates the space formed between LEDs 28 and the light guide plate 20 from the edge of the optical member 18.

The light guide plate 20 is made of a synthetic resin (an acrylic resin such as PMMA or a polycarbonate, for example) that has a refractive index that is sufficiently higher than that of air and almost completely transparent (has excellent light transmission characteristics). As shown in FIG. 2, the light guide plate 20 has a horizontally-long quadrangular shape in a plan view, in a manner similar to the liquid crystal panel 16 and the chassis 22, and is shaped like a plate that is thicker than the optical member 18. The long side direction of the surface of the light guide plate 20 corresponds to the X axis direction, the short side to the Y axis direction, respectively, and the plate thickness direction intersecting with the surface corresponds to the Z axis direction. Each of the side faces on the long side of the light guide plate 20 is the light-receiving face 20a that receives the light emitted from the LEDs 28.

As shown in FIGS. 2 and 3, the light guide plate 20 is disposed such that the light-receiving faces 20a face the LED units 32, a light-exiting surface 20b, which is a primary surface (the front surface), faces the optical member 18, and an opposite surface 20c, which is the surface opposite to the light-exiting surface 20b (the back surface), faces the reflective sheet 26. The light guide plate 20 is supported by the protruding section 22a1, which is described later, of the chassis 22 with the reflective sheet 26 therebetween. The direction in which the light guide plate 20 is lined up with the LED units 32 corresponds to the Y axis direction and the direction in which the light guide plate 20 is lined up with the optical member 18 and the reflective sheet 26 corresponds to the Z axis direction. The light guide plate 20 has a function of receiving light emitted from the LED units 32 along the Y axis direction through the light-receiving faces 20a, having the light travel therethrough while changing the direction of the light toward the optical member 18, and emitting the light through the light-exiting surface 20b.

The reflective sheet 26 has the shape of a rectangular sheet, is made of a synthetic resin, and the surface thereof is white with excellent light-reflecting characteristics. The long-side direction of the reflective sheet 26 corresponds to the X axis direction, the short-side direction of the reflective sheet 26 corresponds to the Y axis direction, and the reflective sheet 26 is arranged so as to be sandwiched between the opposite surface 20c of the light guide plate 20 and the spacers 34, which are described later (refer to FIG. 3). The front side of the reflective sheet 26 has a reflective surface, and this reflective surface touches the opposite surface 20c of the light guide plate 20. The reflective sheet 26 can reflect light that has leaked from the LED units 32 or light guide plate 20 toward the light reflecting surface of the reflective sheet 26. In addition, the reflective sheet 26 is slightly larger than the opposite surface 20c of the light guide plate 20 and, as shown in FIGS. 2 and 3, the edges of the reflective sheet 26 protrude slightly beyond the edges of the light guide plate 20.

The four spacers 34 are respectively arranged so as to be along both long-side directions and both short-side directions of the chassis 22, and have a flat plate-like shape. The spacers 34 are placed on the top surface of the protruding section 22a1 of the chassis 22. The end edge areas of the reflective sheet 26 are sandwiched between the spacers 34 and the light guide plate 20 as described above. As a result of being sandwiched in this manner, the reflective sheet 26 is fixed in place and movement of the reflective sheet in the surface direction of the light guide plate 20 (surface direction of bottom plate 22a of chassis 22 or X-Y plane direction) is restricted. A configuration may be adopted in which part of the outer edges of the reflective sheet 26 is not sandwiched between the spacers 34 and the light guide plate 20, whereby movement of part of the outer edges in the surface direction of the light guide plate 20 is permitted and thus wrinkles generated in the reflective sheet 26 by thermal expansion for example can be eliminated from the part of the outer edges.

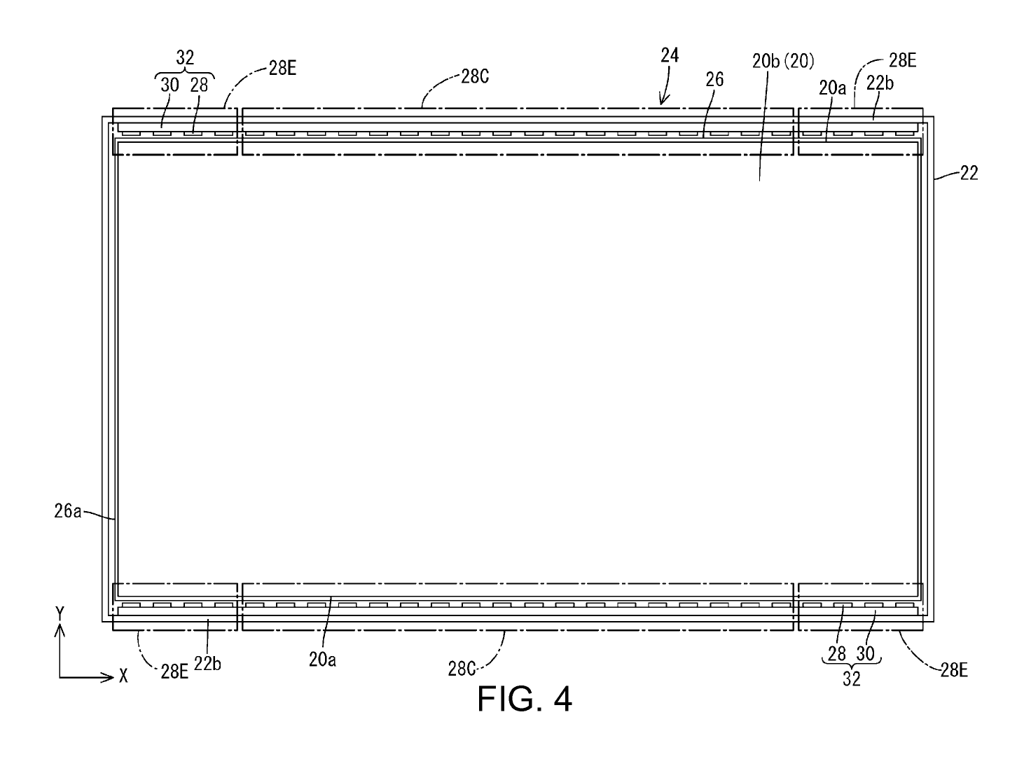

The pair of LED units 32 are respectively arranged along the long sides of the chassis 22 and are each formed of an LED substrate 30 and LEDs 28. As shown in FIGS. 2 and 4, the LED substrate 30 that constitutes the LED unit 32 has a shape of a narrow plate extending along the long side direction (the X axis direction, the long side direction of the light-receiving face 20a) of the light guide plate 20 and is housed inside the chassis 22 such that the surface thereof is parallel to both the X axis direction and the Z axis direction, or in other words, parallel to the light-receiving face 20a of the light guide plate 20. The length in the long side direction (the X axis direction) of each of the LED substrates 30 is about the same as the length in the long side direction of the light guide plate 20. The plurality of LEDs 28, which will be described later, are surface mounted on the inner surface of the LED substrate 30, or in other words, the surface facing the light guide plate 30 (the surface opposing the light guide plate 16), and this surface is a mounting surface 30a. A wiring pattern (not shown) made of metal film (copper foil, for example) is formed on the mounting surface 30a of the LED substrate 30. The wiring pattern extends along the X axis direction and goes across the group of LEDs 28 connecting the adjacent LEDs 28 in series. By connecting to a power supply board via a wiring member such as a connector or a cable, terminals formed at the ends of the wiring pattern supply driving power to each of the LEDs 28. The surface of the LED substrate 30 on the opposite side to the mounting surface 30a is attached to the side plate 22b on the long side of the chassis 22 with screws or the like.

A plurality of the LEDs 28 that constitute the LED unit 32 are arranged on the mounting surface 30a of the LED substrate 30 in a row (linearly) with prescribed gaps therebetween in the length direction (X axis direction) of the LED substrate 30. That is, the plurality of the LEDs 28 are disposed with gaps therebetween on each of the edges of the long sides of the backlight device 24 along the light-receiving faces 20a of the light guide plate 20 (along the long-side direction of the chassis 22). The LEDs 28 are so-called top-emitting type, for which the primary light-emitting face is the surface opposite to the mounting surface 30a of the LED substrate 30 (the surface facing the light-receiving face 20a of the light guide plate 20). The alignment direction of the LEDs 28 corresponds to the long-side direction (the X axis direction) of the LED substrate 30. The gaps between adjacent LEDs 28 in the X axis direction are substantially uniform. In the present specification, substantially uniform gaps means uniform gaps from a design perspective but includes the case where the gaps between the LEDs 28 have become slightly shifted from the prescribed gap due to the LED substrate 30 being attached with screws for example.

Each LED 28 is formed of an LED element 28a and a resin package 28b in which the LED element 28a is sealed. In this embodiment, as shown in FIG. 4, among the plurality of LEDs 28 arranged in a row along the light-receiving face 20a of the light guide plate 20, LEDs 28C arranged in the center of the row (hereafter, referred to as center LED group) are each a type of LED in which one LED element 28a is sealed inside one resin package 28b, that is, a 1-in-1-type LED 28. On the other hand, among the plurality of LEDs 28, LED groups that are arranged relatively closer to the ends of the row, that is, LED groups (hereafter, referred to as end LED groups) 28E that face the ends of the light-receiving face 20a of the light guide plate 20 are made up of a type of LED in which two LED elements 28a are sealed inside one resin package 28b, that is, a 2-in-1-type LED 28.

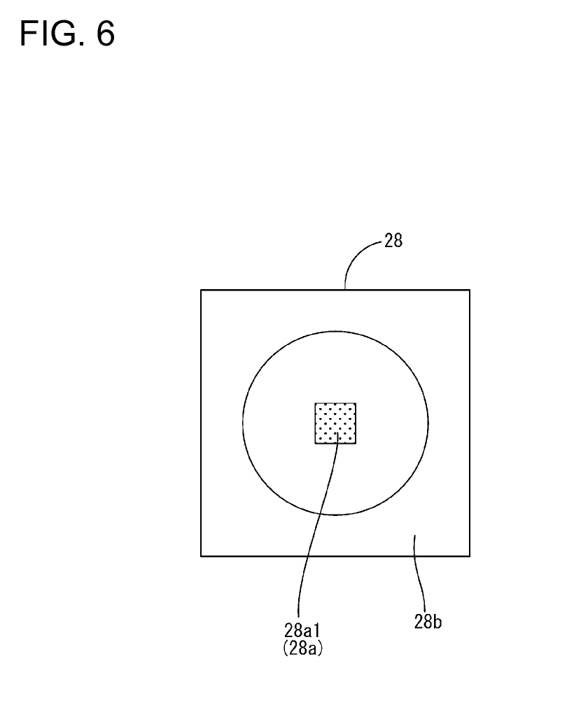

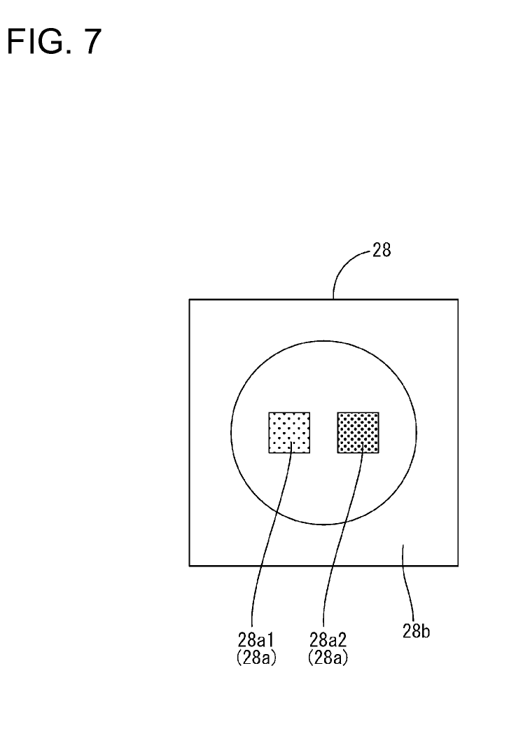

In the 1-in-1-type LED 28, the LED element 28a has one principle light-emission wavelength, and specifically, a blue-light-emitting element 28a1 that emits blue light is used (refer to FIG. 6). A phosphor that emits light of a prescribed color when excited by the blue light emitted from the blue light-emitting element 28a1 is dispersed and mixed into the resin package 28b in which the LED element 28a is sealed, and consequently the structure as a whole emits substantially white light. For the phosphor, a yellow phosphor that emits yellow light, a green phosphor that emits green light, and a red phosphor that emits red light can be combined appropriately for use, or only one of the phosphors can be used, for example. In contrast, in the 2-in-1-type LED 28, the LED elements 28a have two principle light-emission wavelengths, and specifically, a blue-light-emitting element 28a1 and a red-light-emitting element 28a2 that emits red light are used (refer to FIG. 7). In the 2-in-1-type LED 28, as a result of using the blue-light-emitting element 28a1 and the red-light-emitting element 28a2 in combination with each other, the structure as a whole emits substantially white light.

Two LED elements 28a1 and 28a2 are sealed inside the resin package 28b in the 2-in-1-type LED 28 as described above and therefore a greater amount of light is emitted from the light-exiting surface compared with the 1-in-1-type LED 28 in which a single LED element 28a1 is sealed inside the resin package 28b. Therefore, the amount of light emitted from each LED 28 of the end LED groups 28E is greater than the amount of light emitted from each LED 28 of the center LED group 28C. Consequently, the brightness of light entering parts of the light-receiving face 20a of the light guide plate 20 at the ends in the long-side direction of the light guide plate 20, in other words, parts facing the end LED groups 28E, is made relatively higher than the brightness of light entering the part of the light-receiving face 20a in the center in the long-side direction of the light guide plate 20, that is, the part facing the center LED group 28C. As a result, despite there being greater overlapping of light emitted from the LEDs 28 in the center part than in the parts at the ends in the long-side direction of the light guide plate 20, a situation in which the brightness of light emitted from the ends is relatively lower than the brightness of light emitted from the center of the light-exiting surface 20b of the light guide plate 20 can be prevented or suppressed and the brightness in the plane of the light-exiting surface 20b can be made substantially uniform.

In the backlight device 24 according to the embodiment described above, the amount of light entering the ends of the light-receiving face 20a is increased relative to the amount of light entering the center of the light-receiving face 20a, and therefore, even though there is a greater amount of light overlapping in the center than at the ends of the light-receiving face 20a due to the gaps between adjacent LEDs 28 having been made narrower for example, a situation in which there is non-uniformity in the brightness of light between the center and the ends of the light-exiting surface can be prevented or suppressed. In addition, since there are no lens members or the like arranged along the path of light like in the configuration described in the related art, it is also possible to prevent the use efficiency of light from decreasing. As a result, in the backlight device 24 of this embodiment, even in the case where the gaps between adjacent LEDs 28 have become narrower, the uniformity of the brightness distribution of the light-exiting surface 20b of the light guide plate 20 can be improved without decreasing the use efficiency of light.

In addition, in this embodiment, each of the plurality of arranged LEDs 28 includes the LED element 28a and the resin package 28b in which the LED element 28a is sealed. By adopting this configuration, the wiring can be simplified compared with the case where the LEDs 28 are mounted on a substrate or the like in a state where the LED elements 28a are exposed, and therefore the gaps between adjacent LEDs 28 can be made narrower. This allows the frame region of the backlight device 24 to be narrower.

Furthermore, in this embodiment, the plurality of arranged LEDs 28 are configured such that the LEDs 28 arranged relatively closer to the ends of a row have a greater number of LED elements 28a sealed inside a single resin package 28b than the LEDs 28 arranged in the center of the row. In other words, each LED 28 of the center LED group 28C is a 1-in-1-type LED and each LED of the end LED groups 28E are a 2-in-1-type LED. By adopting this configuration, the uniformity of brightness between the center and the ends of the light-exiting surface 20b can be improved by merely changing the type of LEDs 28.

### Modification Example of Embodiment 1

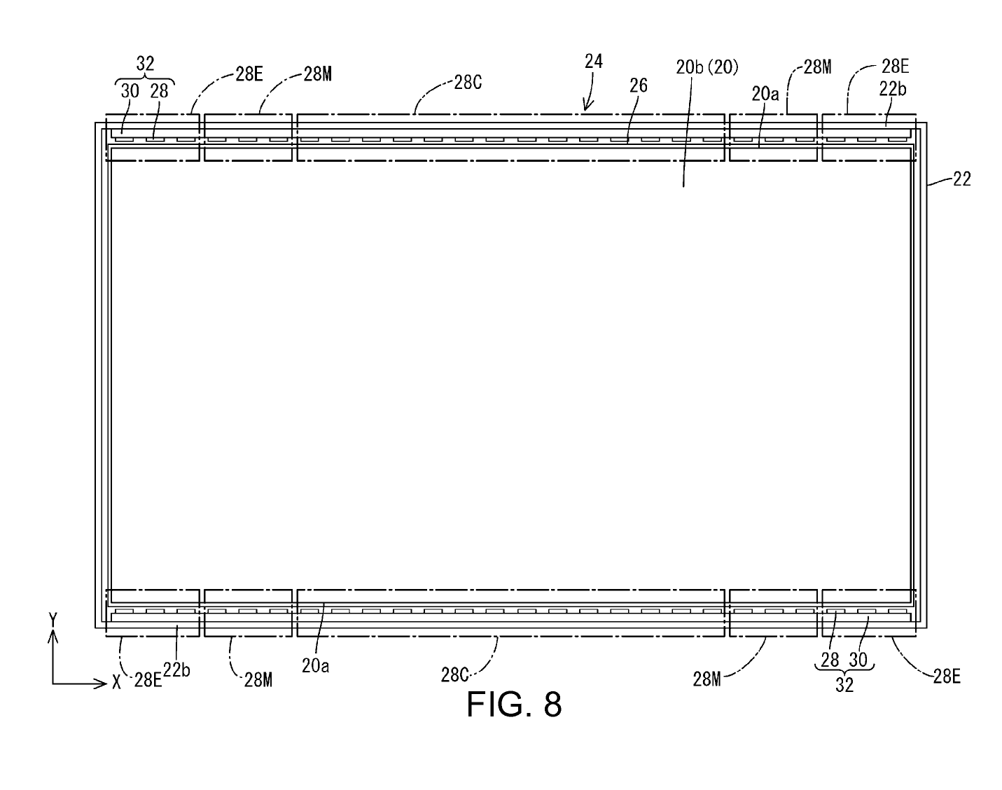

Next, a modification example of Embodiment 1 will be described. This modification example differs from Embodiment 1 in terms of the configuration of the plurality of LEDs 28 arranged in a row. Other configurations are the same as those of Embodiment 1, and therefore, descriptions of the structures, the operation, and the effect are omitted. In the backlight device 24 according to this modification example, as shown in FIG. 8, among the plurality of LEDs 28 arranged in a row along the light-receiving face 20a of the light guide plate 20, the center LED group 28C arranged in the center of the row is formed of the 1-in-1-type LED (example of first LED) 28 similarly to as in Embodiment 1. On the other hand, among the plurality of LEDs 28, the end LED groups 28E arranged at the ends of the row are formed of a type of LED in which three LED elements 28a are sealed inside a single resin package 28b, in other words, a 3-in-1-type LED (example of third LED) 28. LED groups (hereafter, referred to middle LED groups) 28M, which are arranged between the center LED group 28C and the end LED groups 28E, are formed of the 2-in-1-type LED (example of second LED).

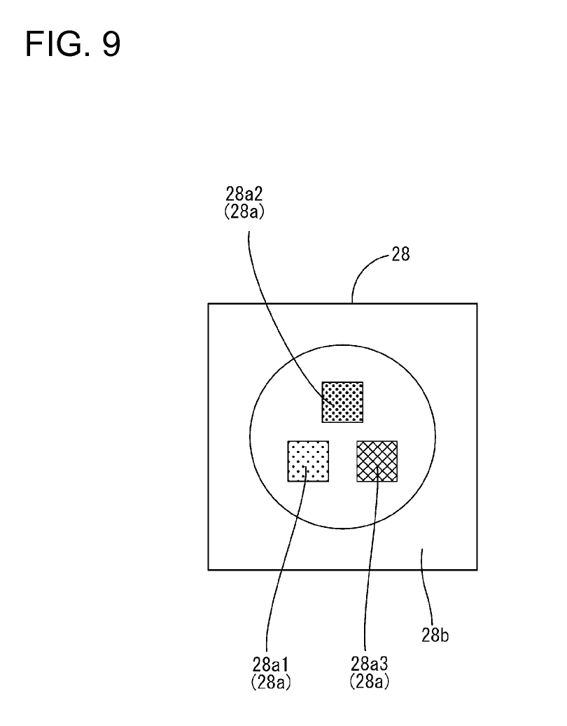

In the above-mentioned 3-in-1-type LED 28, the LED elements 28a have three principle light-emission wavelengths, and specifically, the blue-light-emitting element 28a1, the red-light-emitting element 28a2 and a green-light-emitting element 28a3 that emits green light are used (refer to FIG. 9). In the 3-in-1-type LED 28, as a result of using the blue-light-emitting element 28a1, the red-light-emitting element 28a2 and the green-light-emitting element 28a3 in combination with each other, the structure as a whole emits substantially white light. Therefore, a greater amount of light is emitted from the light-exiting surface with the 3-in-1-type LED 28 compared with the 2-in-1-type LED 28.

In the above-described modification example, in the case where the LEDs 28 each include an LED element and a resin package, by using three types of LED 28, the amount of light emitted from the light-emitting surfaces of the LEDs 28 from the center to the ends of the row of LEDs 28 changes in three steps and therefore the amount of light emitted from the LEDs 28 is more easily adjusted. Thus, the brightness of light entering the light-receiving face 20a of the light guide plate 20 increases in three steps from the center to the ends in the long-side direction of the light guide plate 20. As a result, uniformity of brightness between the center and the ends of the light-exiting surface 20b can be further improved.

### Embodiment 2

Embodiment 2 will be described with reference to the drawings. Embodiment 2 differs from Embodiment 1 in terms of the size of an LED element 128a sealed inside a resin package 128b of some LEDs 128 among LEDs 128. Other configurations are similar to those of Embodiment 1; thus, the descriptions of the configurations, operation, and effects thereof are omitted.

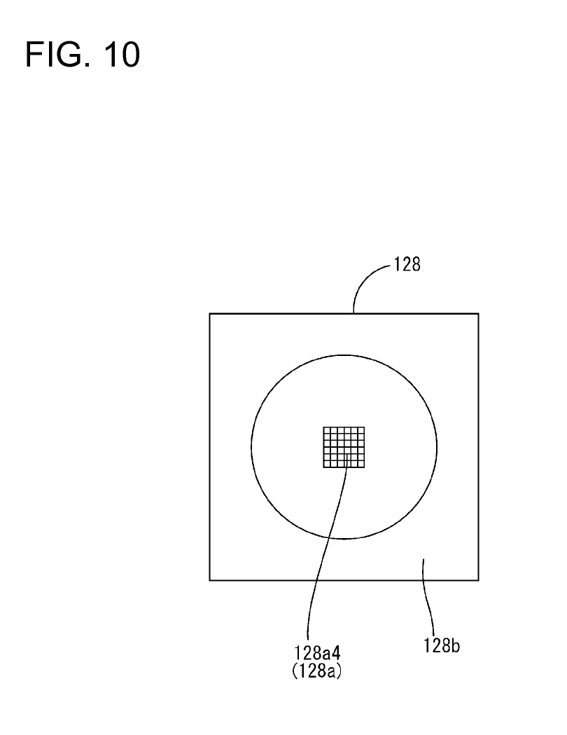

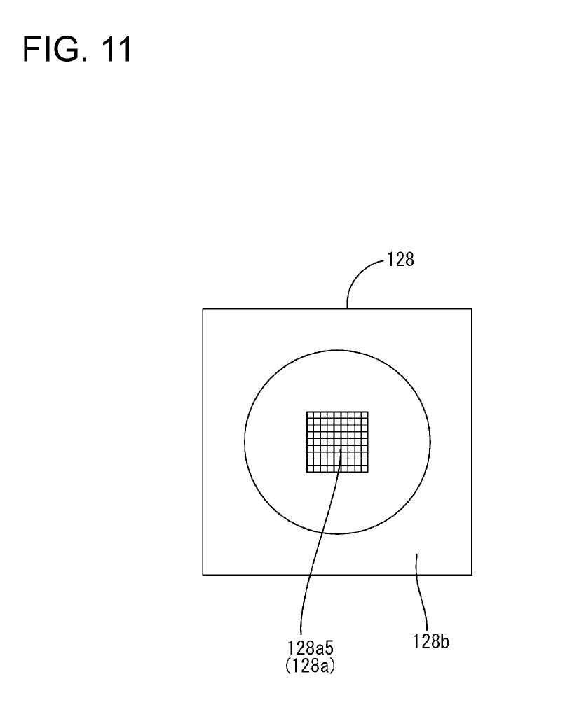

In a backlight device according to Embodiment 2, different to as in Embodiment 1, among a plurality of LEDs 128 arranged in a row along a light-receiving face of a light guide plate 120, both a center LED group and end LED groups are formed of 1-in-1-type LEDs 128. As shown in FIGS. 10 and 11, the size of an LED element 128a sealed inside a resin package 128b of LEDs 128 of the end LED groups is larger than in the LEDs 128 of the center LED group. In other words, a small-size LED element 128a4 is sealed inside the resin package 128b in each LED 128 of the center LED group and a large-size LED element 128a5 is sealed inside a resin package 128b in each LED 128 of the end LED groups. In the above-described embodiment, the uniformity of brightness between the center and the ends of the light-exiting surface can be improved by merely changing the sizes of the LED elements 128a in a case where the LEDs 128 each include an LED element 128a and a resin package 128b.

### Embodiment 3

Next, Embodiment 3 will be described. Embodiment 3 differs from Embodiment 1 in terms of the performance of some of the LEDs. Other configurations are similar to those of Embodiment 1; thus, the descriptions of the configurations, operation, and effects thereof are omitted.

In a backlight device according to Embodiment 3, different to as in Embodiment 1, among a plurality of LEDs arranged in a row along a light-receiving face of a light guide plate, both a center LED group and end LED groups are formed of 1-in-1-type LEDs. LEDs in the end LED groups have a higher performance than the LEDs in the center LED group and the luminous flux of light emitted from the light-exiting surface is larger. In this embodiment, specifically, the performance of the LEDs in the end LED groups is made higher than that of the LEDs in the center LED group by intentionally mounting resin packages having LED elements of a higher quantum efficiency or by mounting larger surface area LED elements per unit surface area. In the above-described embodiment, the uniformity of brightness between the center and the ends of the light-exiting surface can be improved by merely changing the LED performance.

Modification examples of the respective embodiments mentioned above are described below.

(1) In Embodiment 1, an example is described in which the LEDs of the center LED group are 1-in-1-type LEDs and the LEDs of the end LED groups are 2-in-1-type LEDs, but instead 2-in-1-type LEDs may be included in the center LED group and 1-in-1-type LEDs may be included in the end LED groups. It is sufficient that a configuration be adopted such that the amount of light emitted by the LEDs of the end LED groups as a whole is larger than the amount of light emitted by the LEDs of the center LED group.

(2) In Embodiment 2, an example is described in which the size of the LED element sealed inside a resin package is larger in LEDs of the end LED groups than in the LEDs of the center LED group, but instead LEDs having a larger LED element than LEDs of the end LED groups may be included in the center LED group and LEDs having a smaller LED element than the LEDs of the center LED group may be included in the end LED groups. It is sufficient that a configuration be adopted such that the amount of light emitted by the LEDs of the end LED groups as a whole is larger than the amount of light emitted by the LEDs of the center LED group.

(3) In Embodiment 3, an example is described in which the luminous flux of light emitted from the light-emitting surface is larger in LEDs of the end LED groups than in LEDs of the center LED group, but LEDs for which the luminous flux of light emitted from the light-emitting surface is larger than in LEDs of the end LED groups may be included as LEDs of the center LED group and LEDs for which the luminous flux of light emitted from the light-emitting surface is smaller than in LEDs of the center LED group may be included as LEDs of the end LED groups. It is sufficient that a configuration be adopted such that the amount of light emitted by the LEDs of the end LED groups as a whole is larger than the amount of light emitted by the LEDs of the center LED group.

(4) In the above-described embodiments, although an example is described in which a configuration is adopted such that the amount of light emitted by the LEDs of the end LED groups is larger as a whole than the amount of light emitted by the LEDs of the center LED group, it is sufficient that a configuration be adopted such that the amount of light emitted by LEDs of an LED group at at least one end among the two ends of the light-receiving face be larger as a whole than the amount of light emitted by the LEDs of the center LED group.

(5) In the above-described embodiments, although a configuration was described as an example in which each LED includes an LED element and a resin package that seals the LED element thereinside, each LED may instead have a configuration including only an LED element.

(6) In addition to the embodiments described above, configurations in which the amount of light emitted by the LEDs of the end LED groups is larger as a whole than the amount of light emitted by LEDs of the center LED group can be appropriately changed.

(7) Although the respective embodiments described above used as an example of a liquid crystal display device using a liquid crystal panel as a display panel, the present invention is also applicable to a display device that uses another type of display panel.

(8) In the respective embodiments above, a television receiver that includes a tuner was shown as an example, but the present invention is also applicable to a display device without a tuner.

The embodiments of the present invention were described above in detail, but these are only examples, and do not limit the scope as defined by the claims. The technical scope defined by the claims includes various modifications of the specific examples described above.

### DESCRIPTION OF REFERENCE CHARACTERS

TV television receiver
Ca, Cb cabinet
T tuner
S stand
10 liquid crystal display device
12 bezel
14 frame
16 liquid crystal panel
18 optical member
20 light guide plate
20a, 120a light-receiving face
20b, 120b light-exiting surface
22 chassis
24 backlight device
28, 128 LED
28C, 128C center LED group
28E, 128E end LED group
30, 130 LED substrate
32 LED unit

1. An illumination device, comprising:
a light guide plate, at least one end face thereof being a light-receiving face; and
a plurality of light-emitting units arranged in a row along the light-receiving face such that light emitted from the light-emitting units enters the light-receiving face of the light guide plate,
wherein the plurality of light-emitting units are grouped into a plurality of groups such that an amount of light emitted by each light-emitting unit in a center group on a center-side of the row is less than an amount of light emitted by each light-emitting unit in a peripheral group on a relatively end-side of the row.

2. The illumination device according to claim 1,
wherein the plurality of light-emitting units each include at least one light-emitting diode and a resin package that seals said at least one light-emitting diode therein.

3. The illumination device according to claim 2,
wherein each light-emitting unit in said peripheral group on the relatively end-side of the row has a greater number of the light-emitting diodes sealed inside the resin package therein than each light-emitting unit in said center group on the center-side of the row.

4. The illumination device according to claim 3,
wherein each light-emitting unit in said center group on the center-side of the row has one light-emitting diode sealed inside the resin package therein,
wherein each light-emitting unit in said peripheral group on the relatively end-side of the row has three light-emitting diodes sealed inside the resin package therein, and
wherein each light emitting unit in a middle group that is arranged between said center group and said peripheral group has two light-emitting diodes sealed inside the resin package therein.

5. The illumination device according to claim 2,
wherein the light-emitting diode sealed inside the resin package in each light-emitting unit is larger in size in said peripheral group on the relatively end-side of the row than in said center group on the center-side of the row.

6. The illumination device according to claim 2,
wherein a luminous flux of each light-emitting unit in said peripheral group on the relatively end-side of the row is greater than that of each light-emitting unit in said center group on the center side of the row.

7. The illumination device according to claim 1,
wherein the amount of light emitted by each light-emitting unit in said center group on the center-side of the row is less than an amount of light emitted by each light-emitting unit in another peripheral group that is located on another end-side of the row that is opposite to said end side.

8. The illumination device according to claim 1,
wherein the plurality of light-emitting units are arranged along said light-receiving face in a straight line with substantially uniform gaps therebetween.

9. A display device, comprising:
the illumination device according to claim 1; and
a display panel that performs display using light from the illumination device.

10. The display device according to claim 9,
wherein the display panel is a liquid crystal panel that uses liquid crystal.

11. A television receiver, comprising:
the display device according to claim 9.
